(19) United States
(12) Patent Application Publication
(10) Pub. No.: US 2026/0235400 A1
(43) Pub. Date: Aug. 13, 2026

(54) MEASUREMENT APPARATUS AND CONTROL METHOD

(71) Applicant: Yokogawa Electric Corporation, Musashino-shi, Tokyo (JP)

(72) Inventor: Gou Ou, Musashino-shi, Tokyo (JP)

(73) Assignee: Yokogawa Electric Corporation, Musashino-shi, Tokyo (JP)

(21) Appl. No.: 19/150,633

(22) PCT Filed: Nov. 9, 2023
(86) PCT No.: PCT/JP2023/040476

§ 371 Date: Jul. 24, 2025

(30) Foreign Application Priority Data
Jan. 30, 2023 (JP) 2023-012282

(51) Int. Cl. G01B 15/02; G21F 5/04

(52) U.S. Cl. CPC G01B 15/025; G21F 5/04

(57) ABSTRACT

A measurement apparatus measures thickness of an object to be measured using radiation. The measurement apparatus includes a blocker able to block radiation emitted by a radiation source, controllers that control unblocking and blocking of radiation by opening and closing the blocker, and detectors that detect intruders at a boundary of a defined area including the radiation source. The controllers close the blocker to block radiation when the detectors detect an intruder at the boundary of the defined area.

### CROSS-REFERENCE TO RELATED APPLICATION

The present application claims priority to and the benefit of Japanese Patent Application No. 2023-12282 filed Jan. 30, 2023, the entire contents of which are incorporated herein by reference.

### TECHNICAL FIELD

The present disclosure relates to a measurement apparatus and a control method.

### BACKGROUND

Conventionally, in a thickness gauge that measures parameters including thickness of an object to be measured, a thickness gauge safety apparatus has been described that improves safety by inclusion of a shutter to block radiation (see, for example, Patent Literature (PTL) 1).

### CITATION LIST

### Patent Literature

PTL 1: JP H5-55012 U

### SUMMARY

### Technical Problem

Regarding a thickness gauge safety apparatus, when a human, animal, or the like intrudes into the vicinity of a radiation source, the human, animal, or the like that intrudes may be exposed to radiation.

It would be helpful to provide a measurement apparatus and a control method able to suppress exposure of a human, animal, or the like that intrudes into the vicinity of a radiation source.

### Solution to Problem

A measurement apparatus according to at least one embodiment is a measurement apparatus for measuring thickness of an object to be measured using radiation, comprising: a blocker able to block the radiation emitted by a radiation source; a controller configured to control unblocking and blocking of the radiation by opening and closing the blocker; and a detector configured to detect an intruder at a boundary of a defined area that includes the radiation source. The controller closes the blocker to block the radiation when the detector detects an intruder at the boundary of the defined area. Radiation is rapidly blocked when the measurement apparatus detects an intruder at the boundary of the defined area via the detector and closes the blocker. As a result of the rapid blocking of the radiation, the exposure of a human, animal, or the like that intrudes is suppressed.

The measurement apparatus according to an embodiment further comprises a camera able to image capture the defined area. The controller starts the image capture of the defined area by the camera when the detector detects an intruder at the boundary of the defined range. Movement of an intruder is monitored by the measurement apparatus by image capture of the defined area using the camera. Further, an abnormal state of the measurement apparatus may be ascertained.

The measurement apparatus according to an embodiment further comprises a camera able to image capture the defined area. The controller causes the blocker to block when memory usage of the camera is at a usage threshold or greater. When the memory usage of the camera is at the usage threshold or greater, the camera may not be able to image capture the defined area. In a case where the camera becomes unable to image capture the defined area, a safety problem may arise for the measurement apparatus. By causing the blocker to block when the memory usage of the camera is at the usage threshold or greater, a radiation leakage situation in which the blocker fails to close while the camera is unable to image capture the defined area may be prevented.

The measurement apparatus according to an embodiment further comprises a head driver configured to move the radiation source. The detector is disposed so that the defined area moves along with movement of the radiation source. By disposing the detector so that the defined area moves with the movement of the radiation source, an area that a worker may enter around the measurement apparatus is increased. As a result, the space occupied by the measurement apparatus is reduced. Further, worker movement is facilitated.

A control method for a measurement apparatus according to at least one embodiment is a control method for a measurement apparatus that comprises a radiation source and a blocker able to block radiation, the measurement apparatus configured to measure thickness of an object to be measured using the radiation, the control method comprising: detecting an intruder at a boundary of a defined area that includes the radiation source; and closing the blocker to block the radiation when an intruder is detected at the boundary of the defined area. Radiation is rapidly blocked when the measurement apparatus detects an intruder at the boundary of the defined area via the detector and closes the blocker. As a result of the rapid blocking of the radiation, the exposure of a human, animal, or the like that intrudes is suppressed.

### Advantageous Effect

According to the measurement apparatus and the control method of the present disclosure, exposure of a human, animal, or the like that intrudes into the vicinity of the radiation source is suppressed.

### BRIEF DESCRIPTION OF DRAWINGS

In the accompanying drawings:

FIG. 1 is a functional block diagram illustrating a schematic configuration of a measurement apparatus according to a Comparative Example;

FIG. 2 is a flowchart illustrating procedures for controlling the apparatus by a first control line illustrated in FIG. 1;

FIG. 3 is a flowchart illustrating procedures for controlling the apparatus by a second control line illustrated in FIG. 1;

FIG. 4 is a block diagram illustrating a schematic configuration of a measurement apparatus according to an embodiment of the present disclosure;

FIG. 5 is a schematic diagram illustrating an example configuration of a detector including a light emitter and a light receiver;

FIG. 6A is a flowchart illustrating example procedures for controlling the measurement apparatus by a first control line illustrated in FIG. 4;

FIG. 6B is a flowchart illustrating example procedures when a normal power supply is determined to be on in the procedures of FIG. 6A;

FIG. 6C is a flowchart illustrating example procedures when normal conditions have been determined to not be met in the procedures of FIG. 6B;

FIG. 6D is a flowchart illustrating example procedures when intrusion is detected in the procedures of FIG. 6B;

FIG. 7A is a flowchart illustrating example procedures for controlling the measurement apparatus by a second control line illustrated in FIG. 4;

FIG. 7B is a flowchart illustrating example procedures when a normal power supply is determined to be on in the procedures of FIG. 7A;

FIG. 7C is a flowchart illustrating example procedures when normal conditions have been determined to not be met in the procedures of FIG. 7B;

FIG. 7D is a flowchart illustrating example procedures when intrusion is detected in the procedures of FIG. 7B;

FIG. 8 is a schematic diagram illustrating another configuration of the detector;

FIG. 9A is a diagram illustrating an example configuration in which an entire movement range of a measurement head is enclosed by a virtual fence;

FIG. 9B is a diagram illustrating an example configuration in which a defined area enclosed by a virtual fence moves along with movement of the measurement head;

FIG. 10 is a flowchart illustrating procedures for controlling image capture by a first camera; and

FIG. 11 is a flowchart illustrating procedures for controlling image capture by a second camera.

### DETAILED DESCRIPTION

### Comparative Example

According to a Comparative Example, a thickness gauge using radiation is configured to close a radiation shutter by detecting opening of a door leading into and out of an area where the thickness gauge is installed, to prevent leakage of radioactive material.

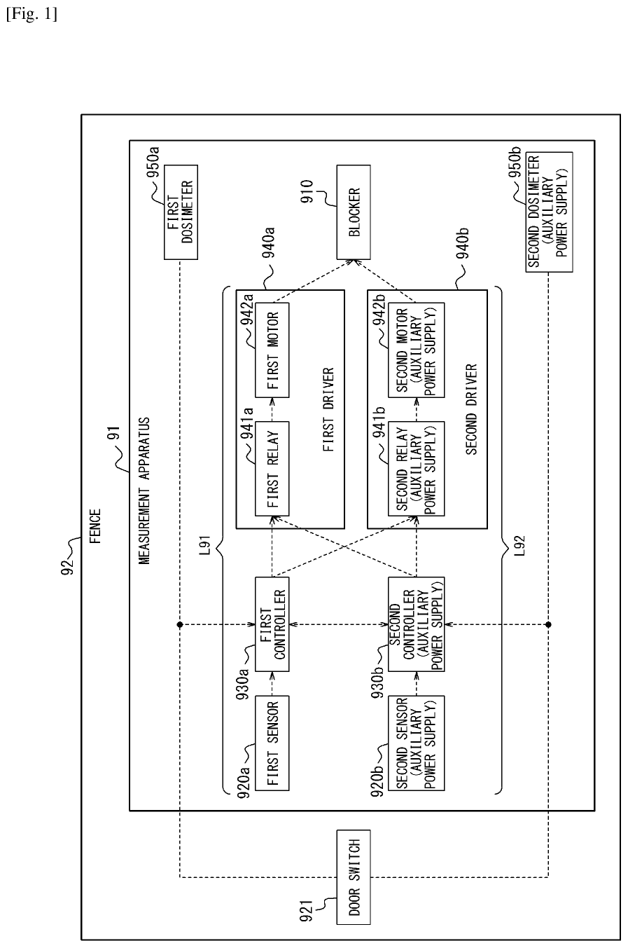

As illustrated in FIG. 1, a measurement apparatus 91 according to the Comparative Example uses radiation to measure thickness of an object to be measured. The measurement apparatus 91 measures the thickness of the object to be measured using attenuation during transmission or reflection of radiation. The measurement apparatus 91 is enclosed by a fence 92. The fence 92 includes a fence enclosing the measurement apparatus 91 to suppress worker exposure to radiation. The fence 92 includes a door that may be opened and closed to allow workers to enter through the fence 92 to perform maintenance work, for example, during maintenance of the measurement apparatus 91.

The fence 92 includes a door switch 921 that is interlocked with the door of the fence 92 when the measurement apparatus 91 is in operation. For example, the door switch 921 turns on when the door of the fence 92 opens and turns off when the door of the fence 92 closes. The door switch 921 is connected to the measurement apparatus 91. The door switch 921 outputs to the measurement apparatus 91 the on or off information of the door switch 921, which reflects an open state or a closed state of the door of the fence 92. The door switch 921 is disabled during maintenance of the measurement apparatus 91.

The measurement apparatus 91 includes a blocker 910 that is able to block radiation emitted by the radiation source used in measuring the thickness of the object to be measured. The blocker 910 includes, for example, a shutter. The blocker 910 is closed under control by the measurement apparatus 91 to block radiation from the radiation source. The blocker 910 is opened under control by the measurement apparatus 91 to allow radiation from the radiation source to pass through without being blocked. The blocker 910 includes, for example, a spring attached to the shutter for when the blocker 910 cannot be driven by a first driver 940a and a second driver 940b described below, and the spring constantly applies a force in the direction of mechanically closing the shutter.

The measurement apparatus 91 includes a first control line L91 and a second control line L92 that control the unblocking and blocking of radiation by opening and closing the blocker 910. The first control line L91 includes a first sensor 920a, a first controller 930a, and the first driver 940a that drives the blocker 910. The second control line L92 includes a second sensor 920b, a second controller 930b, and the second driver 940b that drives the blocker 910. Each component in the second control line L92 has an auxiliary power supply different from a normal power supply.

The first sensor 920a detects a state of a parameter. The first sensor 920a outputs a detection result of the state of the parameter to the first controller 930a as first detection information. The first sensor 920a includes, for example, a temperature sensor, a voltage sensor, a position sensor, and the like. The first sensor 920a detects an abnormal state of a parameter such as high temperature, overvoltage, head separation, and the like as the first detection information, and outputs the first detection information to the first controller 930a.

The first controller 930a includes at least one processor. The first controller 930a is communicatively connected to each component of the measurement apparatus 91 and controls overall operation of the measurement apparatus 91.

The first controller 930a obtains on or off information from the door switch 921 of the fence 92 reflecting the open state or the closed state of the door of the fence 92. The first controller 930a obtains the first detection information output from the first sensor 920a. The first controller 930a is communicatively connected to the second controller 930b. The first controller 930a obtains from the second controller 930b an operating state of the second controller 930b, determination information and control information derived from calculation of the second controller 930b, and any other information required for operation of the measurement apparatus 91. The first controller 930a controls the first driver 940a and the second driver 940b.

The first driver 940a includes a first relay 941a connected to the first controller 930a and the second controller 930b, and a first motor 942a that drives the blocker 910 based on a control signal output from the first controller 930a via the first relay 941a.

The first relay 941a is either on or off based on a control signal from the first controller 930a or the second controller 930b to achieve either a connected state or a blocked state of the first control line L91. The first relay 941a automatically turns off when the normal power supply is lost to achieve the blocked state of the first control line L91. The first motor 942a performs the opening or closing operation of the blocker 910 based on the control signal output from the first controller 930a via the first relay 941a.

The first controller 930a monitors the door switch 921 and the first sensor 920a. The first controller 930a drives the blocker 910 to close by the first motor 942a when, for example, there is an abnormality in the door of the fence 92 or an abnormality in the first detection information from the first sensor 920a.

The second sensor 920B detects a state of a parameter. The second sensor 920b outputs a detection result of the state of the parameter to the second controller 930b as second detection information. The second sensor 920b includes, for example, a temperature sensor, a voltage sensor, a position sensor, and the like. The second sensor 920b detects an abnormal state of a parameter such as high temperature, overvoltage, head separation, and the like as the second detection information, and outputs the second detection information to the second controller 930b.

The second controller 930b includes at least one processor. The second controller 930b is communicatively connected to each component of the measurement apparatus 91 and controls overall operation of the measurement apparatus 91.

The second controller 930b obtains on or off information from the door switch 921 of the fence 92 reflecting the open state or the closed state of the door of the fence 92. The second controller 930b obtains the second detection information output from the second sensor 920b. The second controller 930b is communicatively connected to the first controller 930a. The second controller 930b obtains from the first controller 930a an operating state of the first controller 930a, determination information and control information derived from calculation of the first controller 930a, and any other information required for operation of the measurement apparatus 91. The second controller 930b controls the first driver 940a and the second driver 940b.

The second driver 940b includes a second relay 941b connected to the first controller 930a and the second controller 930b, and a second motor 942b that drives the blocker 910 based on a control signal output from the second controller 930b via the second relay 941b.

The second relay 941b is either on or off based on a control signal from the first controller 930a or the second controller 930b to achieve either a connected state or a blocked state of the second control line L92. The second relay 941b automatically turns off when the normal power supply is lost to achieve the blocked state of the second control line L92. The second motor 942b performs the opening or closing operation of the blocker 910 based on the control signal output from the second controller 930b via the second relay 941b.

The second controller 930b monitors the door switch 921 and the second sensor 920b. The second controller 930b drives the blocker 910 to close by the second motor 942b when, for example, there is an abnormality in the door of the fence 92 or an abnormality in the second detection information from the second sensor 920b.

The first controller 930a and the second controller 930b are communicatively connected to each other. The first controller 930a and the second controller 930b monitor each other periodically or non-periodically. The first controller 930a and the second controller 930b are each able to output a control signal to both the first relay 941a and the second relay 941b.

The measurement apparatus 91 further includes a first dosimeter 950a connected to the first controller 930a. The first dosimeter 950a includes a sensor for detecting radiation dose. The first dosimeter 950a outputs a first radiation dose detected as a measured value to the first controller 930a.

The first controller 930a sets a first threshold value for each of the open state and the closed state of the blocker 910. When obtaining the first radiation dose that is the first threshold value or greater from the first dosimeter 950a as a measured value, the first controller 930a determines that the measured value is abnormal and closes the blocker 910.

The measurement apparatus 91 further includes a second dosimeter 950b connected to the second controller 930b. The second dosimeter 950b includes a sensor for detecting radiation dose. The second dosimeter 950b outputs a second radiation dose detected as a measured value to the second controller 930b. The second dosimeter 950b has an auxiliary power supply different from the normal power supply.

The second controller 930b sets a second threshold value for each of the open state and the closed state of the blocker 910. When obtaining the second radiation dose that is the second threshold value or greater from the second dosimeter 950b as a measured value, the second controller 930b determines that the measured value is abnormal and closes the blocker 910.

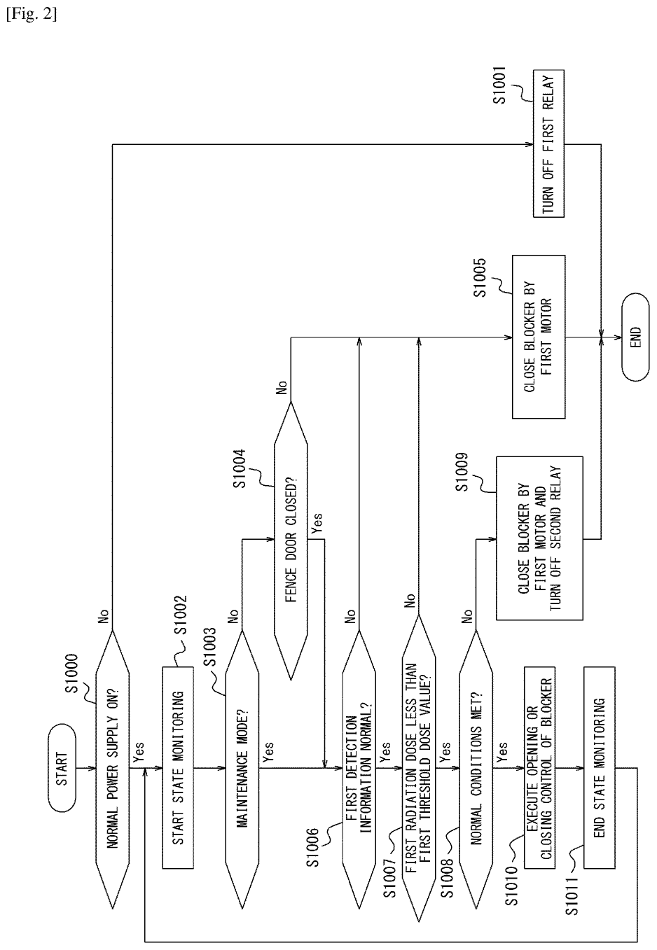

The measurement apparatus 91 according to the Comparative Example controls the measurement apparatus 91 by the first control line L91 illustrated in FIG. 1 by executing the example procedures illustrated in the flowchart of FIG. 2.

As indicated in step S1000, subsequent steps of the control method of the measurement apparatus 91 on the first control line L91 are different depending on whether the normal power supply is supplied and on. When the normal power supply is on, the first controller 930a of the first control line L91 executes the processing of step S1002 and subsequent steps.

When the normal power supply is lost and off, the first relay 941a of the first control line L91 is turned off, as indicated in step S1001. More specifically, when the normal power supply is off while the first relay 941a is on, the first relay 941a transitions from an on state to an off state. When the normal power supply is off while the first relay 941a is off, the first relay 941a remains off. As a result of the above, the first control line L91 enters the blocked state at the first relay 941a.

In step S1002, the first controller 930a becomes operational as the normal power supply is on in step S1000. At this time, the first controller 930a starts state monitoring regarding the measurement apparatus 91.

In step S1003, the first controller 930a determines whether the measurement apparatus 91 is set to a maintenance mode. Upon determining that the measurement apparatus 91 is set to the maintenance mode, the first controller 930a executes the processing of step S1006. Upon determining that the measurement apparatus 91 is set to an operation mode instead of the maintenance mode, the first controller 930a executes the processing of step S1004.

Upon determining that the measurement apparatus 91 is set to the operation mode in step S1003, the first controller 930a, in step S1004, determines whether the door of the fence 92 is closed. In other words, the first controller 930a determines whether the door switch 921 is off. Upon determining that the door of the fence 92 is closed, the first controller 930a executes the processing of step S1006. Upon determining that the door of the fence 92 is open, the first controller 930a executes the processing of step S1005.

Upon determining that the door of the fence 92 is open in step S1004, the first controller 930a, in step S1005, outputs a control signal to the first relay 941a to close the blocker 910 using the first motor 942a of the first driver 940a. Accordingly, the first controller 930a controls the first motor 942a via the first relay 941a to close the blocker 910.

Upon determining that the door of the fence 92 is closed in step S1004, the first controller 930a, in step S1006, determines whether the first detection information from the first sensor 920a is normal. Upon determining that the first detection information is normal, the first controller 930a executes the processing of step S1007. Upon determining that the first detection information is abnormal, the first controller 930a executes the processing of step S1005.

Upon determining that the first detection information is normal in step S1006, the first controller 930a, in step S1007, determines whether the first radiation dose obtained as a measured value from the first dosimeter 950a is less than the first threshold value. Upon determining that the first radiation dose is less than the first threshold value, the first controller 930a executes the processing of step S1008. Upon determining that the first radiation dose is at the first threshold value or greater, the first controller 930a executes the processing of step S1005.

Upon determining that the first radiation dose is less than the first threshold value in step S1007, the first controller 930a, in step S1008, determines whether normal conditions have been met. Upon determining that normal conditions have been met, the first controller 930a executes the processing of step S1010. Upon determining that normal conditions have not been met, the first controller 930a executes the processing of step S1009.

Upon determining that normal conditions have not been met in step S1008, the first controller 930a, in step S1009, outputs a control signal to the first relay 941a and the second relay 941b to close the blocker 910 using the first motor 942a of the first driver 940a and turn off the second relay 941b of the second driver 940b. Accordingly, the first controller 930a controls the first motor 942a via the first relay 941a to close the blocker 910 and controls the second relay 941b to turn off.

Upon determining that normal conditions have been met in step S1008, the first controller 930a, in step S1010, outputs a control signal based on control information to the first relay 941a that causes the blocker 910 to execute normal opening or closing control. In other words, the first controller 930a executes normal opening or closing control of the blocker 910 via the first motor 942a.

In step S1011, the first controller 930a ends the state monitoring regarding the measurement apparatus 91. The first controller 930a then repeats processing from step S1002 onwards.

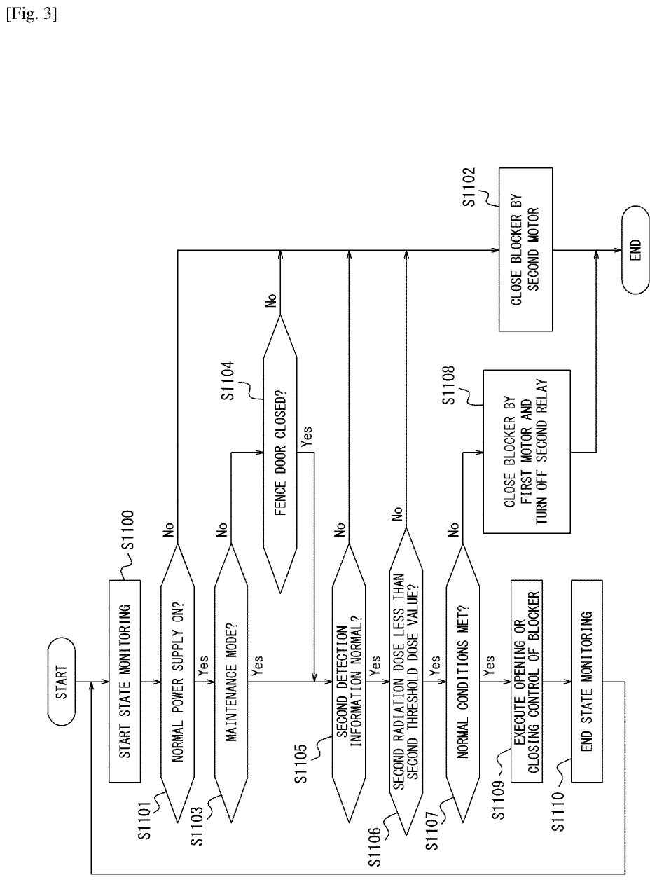

The measurement apparatus 91 according to the Comparative Example controls the measurement apparatus 91 by the second control line L92 illustrated in FIG. 1 by executing the example procedures illustrated in the flowchart of FIG. 3.

In step S1100, the second controller 930b of the second control line L92 may be operated by the normal power supply or an auxiliary power supply. At this time, the second controller 930b starts state monitoring regarding the measurement apparatus 91.

In step S1101, the second controller 930b determines whether the normal power supply is supplied and on. Upon determining that the normal power supply is on, the second controller 930b executes the processing of step S1103. Upon determining that the normal power supply is off, the second controller 930b executes the processing of step S1102.

Upon determining that the normal power supply is off in step S1101, the second controller 930b, in step S1102, outputs a control signal to the second relay 941b to close the blocker 910 using the second motor 942b of the second driver 940b. Accordingly, the second controller 930b controls the second motor 942b via the second relay 941b to close the blocker 910. The above series of processing by the second control line L92 is executed using the auxiliary power supply of each component.

In step S1103, the second controller 930b determines whether the measurement apparatus 91 is set to the maintenance mode. Upon determining that the measurement apparatus 91 is set to the maintenance mode, the second controller 930b executes the processing of step S1105. Upon determining that the measurement apparatus 91 is set to the operation mode instead of the maintenance mode, the second controller 930b executes the processing of step S1104.

Upon determining that the measurement apparatus 91 is set to the operation mode in step S1103, the second controller 930b, in step S1104, determines whether the door of the fence 92 is closed. In other words, the second controller 930b determines whether the door switch 921 is off. Upon determining that the door of the fence 92 is closed, the second controller 930b executes the processing of step S1105. Upon determining that the door of the fence 92 is open, the second controller 930b executes the processing of step S1102. At this time, regarding step S1102, the series of processing by the second control line L92 may be executed using the auxiliary power supply of each component or using the normal power supply.

Upon determining that the door of the fence 92 is closed in step S1104, the second controller 930b, in step S1105, determines whether the second detection information from the second sensor 920b is normal. Upon determining that the second detection information is normal, the second controller 930b executes the processing of step S1106. Upon determining that the second detection information is abnormal, the second controller 930b executes the processing of step S1102. At this time, regarding step S1102, the series of processing by the second control line L92 may be executed using the auxiliary power supply of each component or using the normal power supply.

Upon determining that the second detection information is normal in step S1105, the second controller 930b, in step S1106, determines whether the second radiation dose obtained as a measured value from the second dosimeter 950b is less than the second threshold value. Upon determining that the second radiation dose is less than the second threshold value, the second controller 930b executes the processing of step S1107. Upon determining that the second radiation dose is at the second threshold value or greater, the second controller 930b executes the processing of step S1102. At this time, regarding step S1102, the series of processing by the second control line L92 may be executed using the auxiliary power supply of each component or using the normal power supply.

Upon determining that the second radiation dose is less than the second threshold value in step S1106, the second controller 930b, in step S1107, determines whether normal conditions have been met. Upon determining that normal conditions have been met, the second controller 930b executes the processing of step S1109. Upon determining that normal conditions have not been met, the second controller 930b executes the processing of step S1108.

Upon determining that normal conditions have not been met in step S1107, the second controller 930b, in step S1108, outputs a control signal to the first relay 941a and the second relay 941b to close the blocker 910 using the second motor 942b of the second driver 940b and turn off the first relay 941a of the first driver 940a. Accordingly, the second controller 930b controls the second motor 942b via the second relay 941b to close the blocker 910 and controls the first relay 941a to turn off.

Upon determining that normal conditions have been met in step S1107, the second controller 930b, in step S1109, outputs a control signal based on the control information to the second relay 941b that causes the blocker 910 to execute normal opening or closing control. In other words, the second controller 930b executes normal opening or closing control of the blocker 910 via the second motor 942b.

In step S1110, the second controller 930b ends the state monitoring regarding the measurement apparatus 91. The second controller 930b then repeats processing from step S1100 onwards.

The measurement apparatus 91 according to the Comparative Example described above is able to improve safety with respect to radiation by reliably driving the blocker 910 that includes the shutter. However, when a human, animal, or the like intrudes into a restricted area enclosed by the fence 92 without passing through the door of the fence 92, the door switch 921 is not activated. In such a case, when a human, animal, or the like intrudes into the restricted area, there is a risk of the blocker 910 not closing, and the human, animal, or the like may be exposed to radiation.

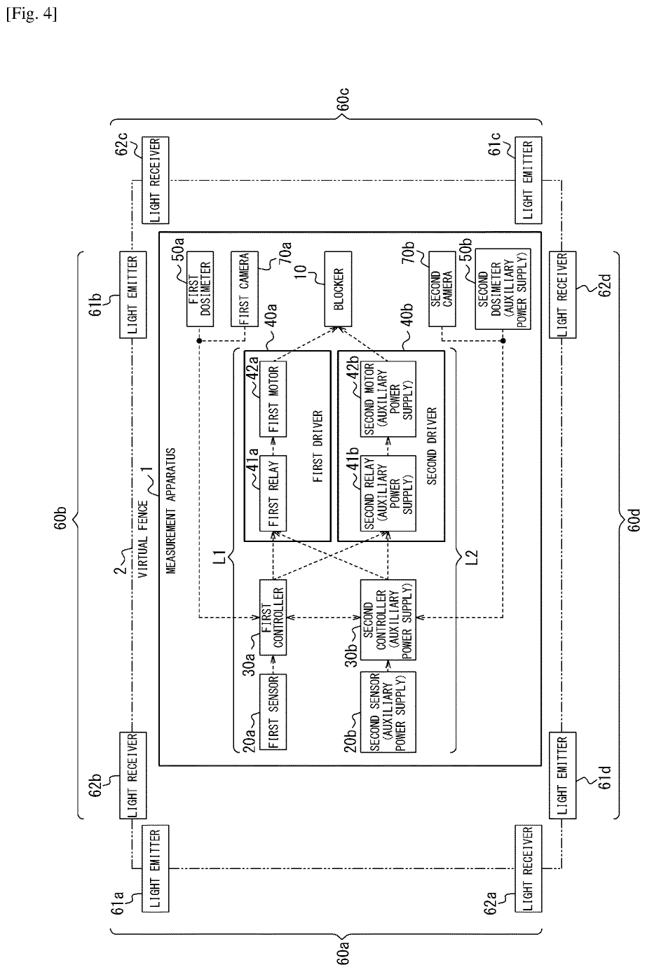

A measurement apparatus 1 (see FIG. 4 and other drawings) according to the present disclosure is able to suppress the exposure of a human, animal, or the like that intrudes into the restricted area without passing through the door. The following describes an example configuration of the measurement apparatus 1 according to an embodiment of the present disclosure, with reference to the drawings.

### Embodiment According to the Present Disclosure

As illustrated in FIG. 4, the measurement apparatus 1 according to an embodiment of the present disclosure is installed in a defined area enclosed by a virtual fence 2 composed of detectors 60a, 60b, 60c, and 60d.

The measurement apparatus 1 measures thickness of an object to be measured using radiation. The measurement apparatus 1 includes a thickness gauge that measures the thickness of the object to be measured using attenuation during transmission or reflection of radiation. Hereinafter, “object to be measured” includes, for example, paper, as well as relatively thin films, plastic sheets, and the like that have a thickness of some millimeters or less.

The defined area enclosed by the virtual fence 2 corresponds to an area in which a worker may be exposed to radiation when the measurement apparatus 1 emits radiation to measure the thickness of the object to be measured. The measurement apparatus 1 suppresses exposure of humans, including workers, or animals or the like that intrude inside the virtual fence 2 by suppressing emission of radiation when a human, animal, or the like intrudes.

The detector 60a includes a light emitter 61a and a light receiver 62a. The detector 60b includes a light emitter 61b and a light receiver 62b. The detector 60c includes a light emitter 61c and a light receiver 62c. The detector 60d includes a light emitter 61d and a light receiver 62d. The detectors 60a, 60b, 60c, and 60d may also be referred to as detectors 60. The light emitters 61a, 61b, 61c, and 61d may also be referred to as light emitters 61. The light receivers 62a, 62b, 62c, and 62d may also be referred to as light receivers 62. The detectors 60 are arranged so that lines connecting the light emitters 61 and the light receivers 62 are the boundary of the defined area. In other words, the lines connecting the light emitters 61 and the light receivers 62, which constitute the boundary of the defined area, correspond to the virtual fence 2.

The number of combinations of the light emitters 61 and the light receivers 62 included in the measurement apparatus 1 as the detectors 60 is not limited to four sets as illustrated in FIG. 4. The number of combinations of the light emitters 61 and the light receivers 62 may be three, five, or more, as long as the defined area can be enclosed by lines connecting the light emitters 61 and the light receivers 62.

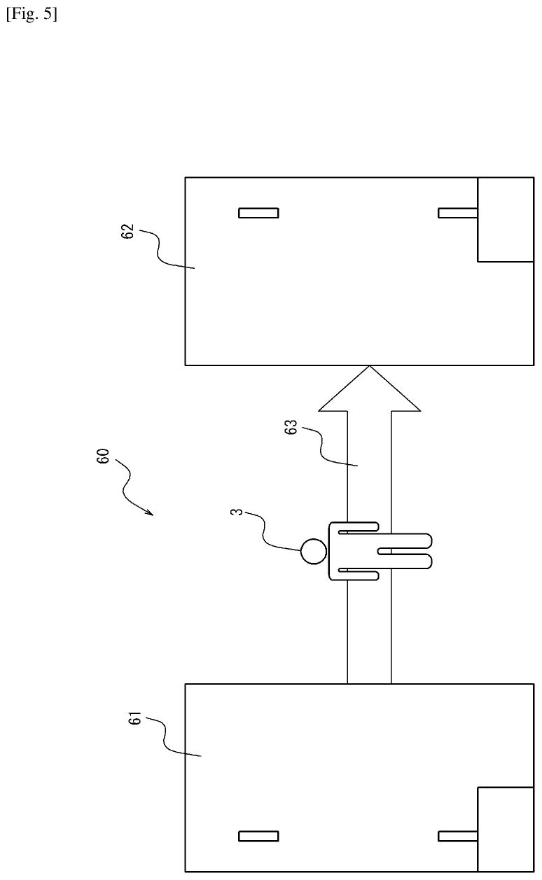

As illustrated in FIG. 5, the detectors 60 may each include a light emitter 61 and a light receiver 62. The light emitter 61 emits detection light 63 towards the light receiver 62. When a detection target 3 is present between the light emitter 61 and the light receiver 62, the detection light 63 is blocked by the detection target 3 and is not incident on the light receiver 62. When the detection target 3 is not present between the light emitter 61 and the light receiver 62, the detection light 63 is incident on the light receiver 62. Therefore, the detector 60 determines that the detection target 3 is not present between the light emitter 61 and the light receiver 62 when the light receiver 62 detects the detection light 63, and determines that the detection target 3 is present between the light emitter 61 and the light receiver 62 when the light receiver 62 does not detect the detection light 63. In other words, the detector 60 operates as a light-shielding sensor and is able to detect the presence of the detection target 3 that has intruded into the virtual fence 2. The detection target 3 may also referred to as an intruder.

The detection light 63 may include, for example, near-infrared or visible light. The light emitter 61 may be configured to include, for example, a laser diode (LD), a light emitting diode (LED), or the like. The light receiver 62 may be configured to include various light-receiving elements, such as photodiodes, phototransistors, or the like.

The measurement apparatus 1 includes a blocker 10 that is able to block radiation emitted by the radiation source used in measuring the thickness of the object to be measured. The blocker 10 includes, for example, a shutter. The blocker 10 is closed under control by the measurement apparatus 1 to block radiation from the radiation source. The blocker 10 is opened under control by the measurement apparatus 1 to allow radiation from the radiation source to pass through without being blocked. The blocker 10 includes, for example, a spring attached to the shutter for when the blocker 10 cannot be driven by a first driver 40a and a second driver 40b described below, and the spring constantly applies a force in the direction of mechanically closing the shutter.

The measurement apparatus 1 includes a first control line L1 and a second control line L2 that control the unblocking and blocking of radiation by opening and closing the blocker 10. The first control line L1 includes a first sensor 20a, a first controller 30a, and the first driver 40a that drives the blocker 10. The second control line L2 includes a second sensor 20b, a second controller 30b, and a second driver 40b that drives the blocker 10. Each component in the second control line L2 has an auxiliary power supply different from the normal power supply.

Hereinafter, “normal power supply” includes, for example, an external power supply that enables operation of the measurement apparatus 1. “Auxiliary power supply” includes, for example, a single-use primary battery, a rechargeable battery that may be recharged and used repeatedly, an uninterruptible power supply (UPS), and the like.

Each component in the second control line L2 may be operated by the auxiliary power supply even when the normal power supply is lost and off. The auxiliary power supply may be chargeable when the normal power supply is on and supplied.

The first sensor 20a detects a state of a parameter. The first sensor 20a outputs a detection result of the state of the parameter to the first controller 30a as first detection information. Hereinafter, “parameter” includes, for example, the environment in which the measurement apparatus 1 is located, that is, the temperature in the defined area, internal temperature of the measurement apparatus 1, voltage generated in the measurement apparatus 1, relative positions between a pair of heads that respectively emit and detect radiation, and the like. The first sensor 20a includes, for example, a temperature sensor, a voltage sensor, a position sensor, and the like. The first sensor 20a detects an abnormal state of a parameter such as high temperature, overvoltage, head separation, and the like as the first detection information, and outputs the first detection information to the first controller 30a.

The first controller 30a includes at least one processor. According to the present embodiment, a “processor” may be, but is not limited to, a general-purpose processor or a dedicated processor specialized for particular processing. The first controller 30a is communicatively connected to each component of the measurement apparatus 1 and controls overall operation of the measurement apparatus 1.

The first controller 30a obtains a detection result of intrusion by the detection target 3 into the virtual fence 2 from the detectors 60. The first controller 30a obtains the first detection information output from the first sensor 20a. The first controller 30a is communicatively connected to the second controller 30b. The first controller 30a obtains from the second controller 30b an operating state of the second controller 30b, determination information and control information derived from calculation of the second controller 30b, and any other information required for operation of the measurement apparatus 1. The first controller 30a controls the first driver 40a and the second driver 40b.

The first driver 40a includes a first relay 41a connected to the first controller 30a and the second controller 30b, and a first motor 42a that drives the blocker 10 based on a control signal output from the first controller 30a via the first relay 41a.

The first relay 41a is either on or off based on a control signal from the first controller 30a or the second controller 30b to achieve either a connected state or a blocked state of the first control line L1. The first relay 41a automatically turns off when the normal power supply is lost to achieve the blocked state of the first control line L1. The first motor 42a performs the opening or closing operation of the blocker 10 based on the control signal output from the first controller 30a via the first relay 41a.

The first controller 30a monitors the detectors 60 and the first sensor 20a. The first controller 30a drives the blocker 10 to close by the first motor 42a when, for example, the detection target 3 intrudes into the virtual fence 2, or when there is an abnormality in the detectors 60 or in the first detection information from the first sensor 20a.

The second sensor 20b detects a state of a parameter. The second sensor 20b outputs a detection result of the state of the parameter to the second controller 30b as second detection information. The second sensor 20b includes, for example, a temperature sensor, a voltage sensor, a position sensor, and the like. The second sensor 20b detects an abnormal state of a parameter such as high temperature, overvoltage, head separation, and the like as the second detection information, and outputs the second detection information to the second controller 30b.

The second controller 30b includes at least one processor. According to the present embodiment, a “processor” may be, but is not limited to, a general-purpose processor or a dedicated processor specialized for particular processing. The second controller 30b is communicatively connected to each component of the measurement apparatus 1 and controls overall operation of the measurement apparatus 1.

The second controller 30b obtains a detection result of intrusion by the detection target 3 into the virtual fence 2 from the detectors 60. The second controller 30b obtains the second detection information output from the second sensor 20b. The second controller 30b is communicatively connected to the first controller 30a. The second controller 30b obtains from the first controller 30a an operating state of the first controller 30a, determination information and control information derived from calculation of the first controller 30a, and any other information required for operation of the measurement apparatus 1. The second controller 30b controls the first driver 40a and the second driver 40b.

The second driver 40b includes a second relay 41b connected to the first controller 30a and the second controller 30b, and a second motor 42b that drives the blocker 10 based on a control signal output from the second controller 30b via the second relay 41b.

The second relay 41b is either on or off based on a control signal from the first controller 30a or the second controller 30b to achieve either a connected or a blocked state of the second control line L2. The second relay 41b automatically turns off when the normal power supply is lost to achieve the blocked state of the second control line L2. The second motor 42b performs the opening or closing operation of the blocker 10 based on the control signal output from the second controller 30b via the second relay 41b.

The second controller 30b monitors the detectors 60 and the second sensor 20b. The second controller 30b drives the blocker 10 to close by the second motor 42b when, for example, the detection target 3 intrudes into the virtual fence 2, or when there is an abnormality in the detectors 60 or in the second detection information from the second sensor 20b.

The first controller 30a and the second controller 30b are communicatively connected to each other. The first controller 30a and the second controller 30b monitor each other periodically or non-periodically. The first controller 30a and the second controller 30b are each able to output a control signal to both the first relay 41a and the second relay 41b.

The measurement apparatus 1 further includes a first dosimeter 50a connected to the first controller 30a. The first dosimeter 50a includes a sensor for detecting radiation dose. The first dosimeter 50a outputs a first radiation dose detected as a measured value to the first controller 30a.

The first controller 30a sets a first threshold dose value for each of the open state and the closed state of the blocker 10. When obtaining the first radiation dose that is the first threshold dose value or greater from the first dosimeter 50a as a measured value, the first controller 30a determines that the measured value is abnormal and closes the blocker 10.

The measurement apparatus 1 further includes a second dosimeter 50b connected to the second controller 30b. The second dosimeter 50b includes a sensor for detecting radiation dose. The second dosimeter 50b outputs a second radiation dose detected as a measured value to the second controller 30b. The second dosimeter 50b has an auxiliary power supply different from the normal power supply.

The second controller 30b sets a second threshold dose value for each of the open state and the closed state of the blocker 10. When obtaining the second radiation dose that is the second threshold dose value or greater from the second dosimeter 50b as a measured value, the second controller 30b determines that the measured value is abnormal and closes the blocker 10.

The measurement apparatus 1 further includes a first camera 70a connected to the first controller 30a and a second camera 70b connected to the second controller 30b. The first camera 70a and the second camera 70b are configured to capture images of the defined area enclosed by the virtual fence 2. The first camera 70a may be configured to capture the entire defined area with a single camera, and may be configured to capture the entire defined area by capturing a portion of the defined area with each of multiple cameras. The second camera 70b may be configured to capture the entire defined area with a single camera, and may be configured to capture the entire defined area by capturing a portion of the defined area with each of multiple cameras.

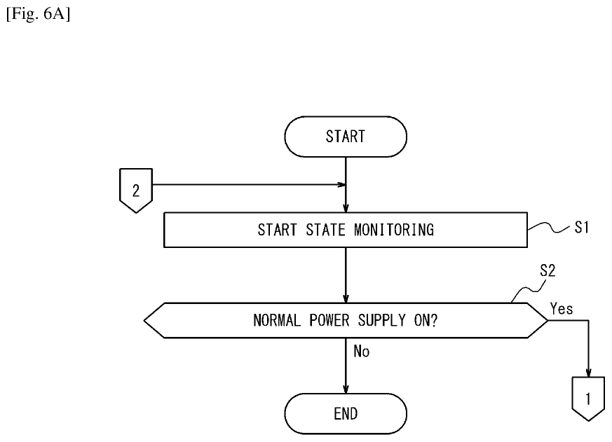

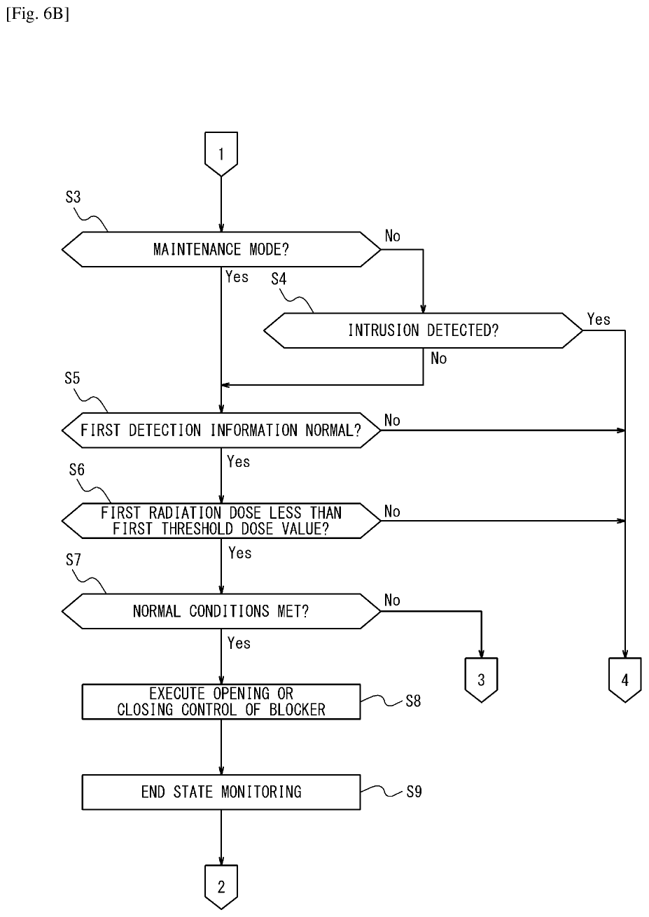

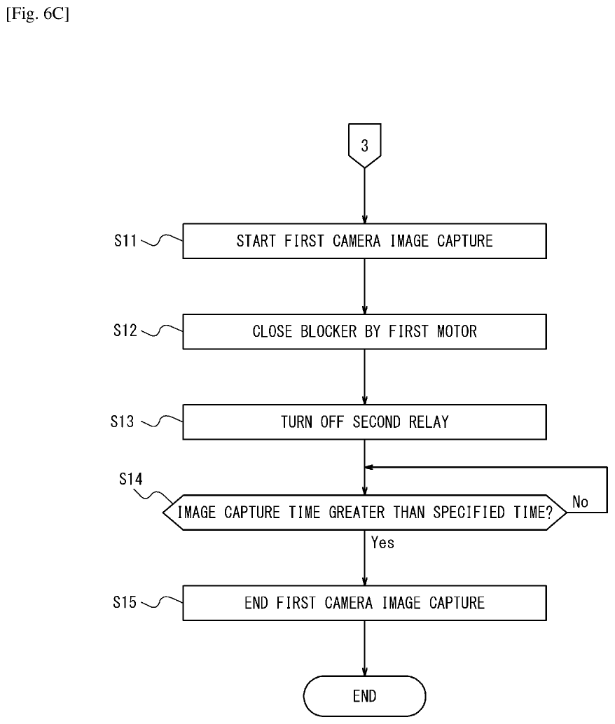

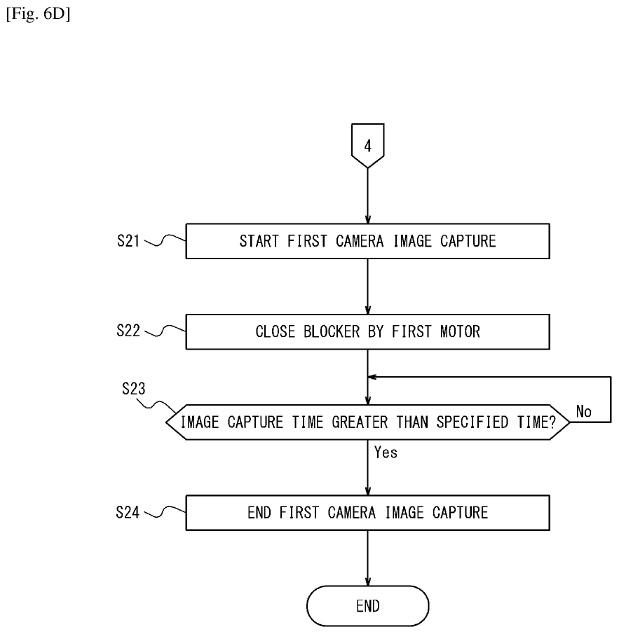

The measurement apparatus 1 may execute the example procedures illustrated in the flowcharts of FIG. 6A, FIG. 6B, FIG. 6C, and FIG. 6D to control the measurement apparatus 1 by the first control line L1 illustrated in FIG. 4.

The first controller 30a starts state monitoring regarding the measurement apparatus 1 (step S1 in FIG. 6A). The first controller 30a determines whether the normal power supply is on (step S2). When the normal power supply is on (step S2: Yes), the first controller 30a proceeds to step S3 in FIG. 6B. When the normal power supply is not on (step S2: No), that is, when the normal power supply is off, the first controller 30a ends execution of the procedures of the flowchart of FIG. 6A.

When the normal power supply is lost and off, the first relay 41a of the first control line L1 is turned off. Specifically, when the normal power supply is off while the first relay 41a is on, the first relay 41a transitions from an on state to an off state. When the normal power supply is off while the first relay 41a is off, the first relay 41a remains off. As a result of the above, the first control line L1 enters the blocked state at the first relay 41a.

Upon determining that the normal power supply is on in step S2 in FIG. 6A, the first controller 30a determines whether the measurement apparatus 1 is set to the maintenance mode (step S3 in FIG. 6B). When the measurement apparatus 1 is not set to maintenance mode (step S3: No), that is, when the measurement apparatus 1 is set to the operation mode, the first controller 30a determines whether intrusion into the virtual fence 2 has been detected by the detectors 60 (step S4). Upon detecting intrusion into the virtual fence 2 by the detectors 60 (step S4: Yes), the first controller 30a proceeds to step S21 in FIG. 6D.

When the measurement apparatus 1 is set to the maintenance mode (step S3: Yes) or no intrusion into the virtual fence 2 is detected by the detectors 60 (step S4: No), the first controller 30a determines whether the first detection information from the first sensor 20a is normal (step S5). When the first detection information is not normal (step S5: No), the first controller 30a proceeds to step S21 in FIG. 6D.

When the first detection information is normal (step S5: Yes), the first controller 30a determines whether the first radiation dose obtained as a measured value from the first dosimeter 50a is less than the first threshold dose value (step S6). When the first radiation dose is not less than the first threshold dose value (step S6: No), that is, when the first radiation dose is the first threshold dose value or greater, the first controller 30a proceeds to step S21 in FIG. 6D.

When the first radiation dose is less than the first threshold dose value (step S6: Yes), the first controller 30a determines whether normal conditions have been met (step S7). When normal conditions have not been met (step S7: No), the first controller 30a proceeds to step S11 in FIG. 6C.

When normal conditions have been met (step S7: Yes), the first controller 30a executes opening or closing control of the blocker 10 using the first motor 42a of the first driver 40a (step S8). Specifically, the first controller 30a outputs a control signal based on first control information to the first relay 41a that causes the blocker 10 to execute normal opening or closing control. The first controller 30a outputs the control signal to the first relay 41a to open the blocker 10 when measurement is to be performed by the measurement apparatus 1 and to close the blocker 10 when measurement is not to be performed by the measurement apparatus 1.

The first controller 30a determines that normal conditions have not been met when, for example, the second controller 30b fails and any control information, including the first control information, is not received from the second controller 30b. The first controller 30a determines that normal conditions have not been met upon receiving the second control information from the second controller 30b that is different from the first control information. Hereinafter, “second control information” includes, for example, control information for closing the blocker 10 using the first motor 42a due to an abnormality in the first detection information, or control information for closing the blocker 10 using the second motor 42b due to an abnormality in the second detection information. In step S107, the second control information includes control information to close the blocker 10 using the second motor 42b due to an abnormality in the second detection information from the second sensor 20b.

After controlling the opening or closing of the blocker 10 according to the procedure in step S8, the first controller 30a ends the state monitoring regarding the measurement apparatus 1 (step S9). The first controller 30a then returns to step S1 in FIG. 6A and repeats processing.

Upon determining that normal conditions have not been met in step S7 of FIG. 6B (step S7: No), the first controller 30a starts image capture of the defined area by the first camera 70a (step S11 in FIG. 6C). The first controller 30a closes the blocker 10 using the first motor 42a (step S12). The first controller 30a turns off the second relay 41b (step S13).

The first controller 30a determines whether the image capture time by the first camera 70a is longer than a specified time (step S14). When the image capture time is not longer than the specified time (step S14: No), that is, when the image capture time is the specified time or less, the first controller 30a repeats the determination procedure of step S14 without ending the image capture by the first camera 70a, until the image capture time is longer than the specified time. When the image capture time is longer than the specified time (step S14: Yes), the first controller 30a ends the image capture by the first camera 70a (step S15). After execution of the procedure in step S15, the first controller 30a ends execution of the procedures of the flowchart of FIG. 6C.

Upon determining that intrusion has been detected by the detectors 60 in step S4 of FIG. 6B, or determining that the first detection information is abnormal in step S5 of FIG. 6B, or determining that the first radiation dose is the first threshold dose value or greater in step S6 of FIG. 6B, the first controller 30a starts image capture of the defined area by the first camera 70a (step S21 in FIG. 6D). The first controller 30a closes the blocker 10 using the first motor 42a (step S22).

The first controller 30a determines whether the image capture time by the first camera 70a is longer than the specified time (step S23). When the image capture time is not longer than the specified time (step S23: No), that is, when the image capture time is the specified time or less, the first controller 30a repeats the determination procedure of step S23 without ending the image capture by the first camera 70a, until the image capture time is longer than the specified time. When the image capture time is longer than the specified time (step S23: Yes), the first controller 30a ends the image capture by the first camera 70a (step S24). After execution of the procedure in step S24, the first controller 30a ends execution of the procedures of the flowchart of FIG. 6D. The first controller 30a does not turn off the second relay 41b in the flowchart of FIG. 6D, unlike the flowchart of FIG. 6C.

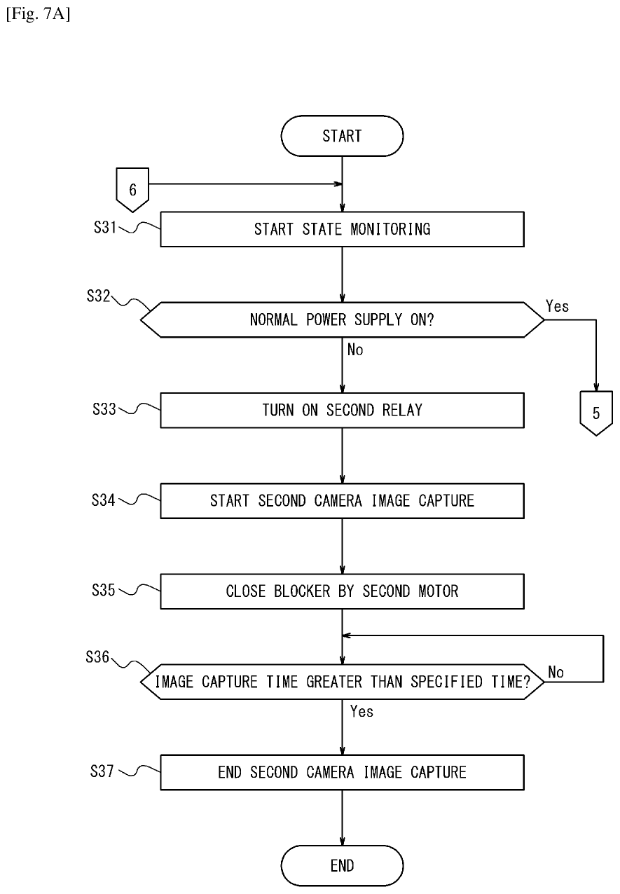

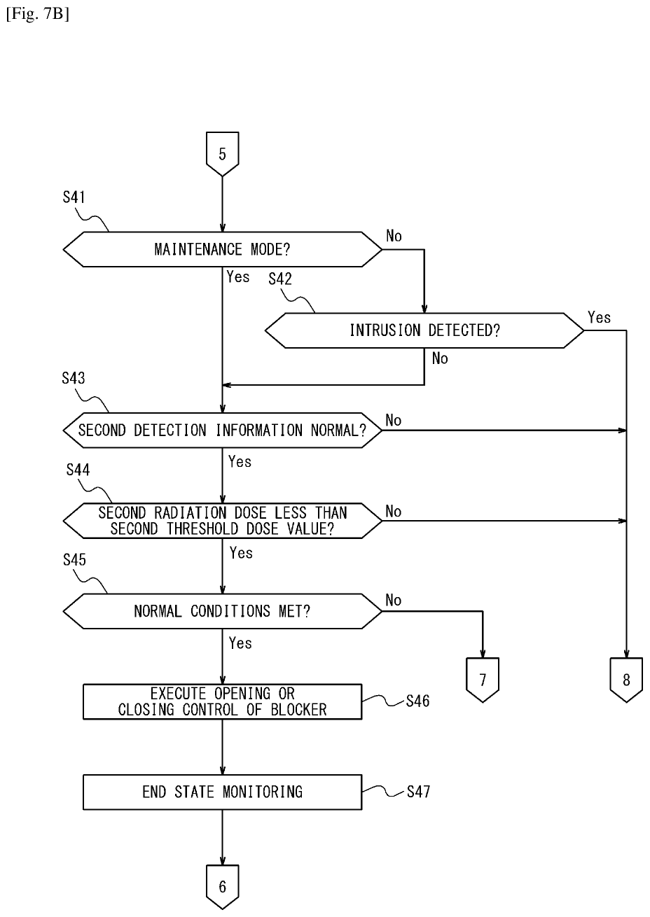

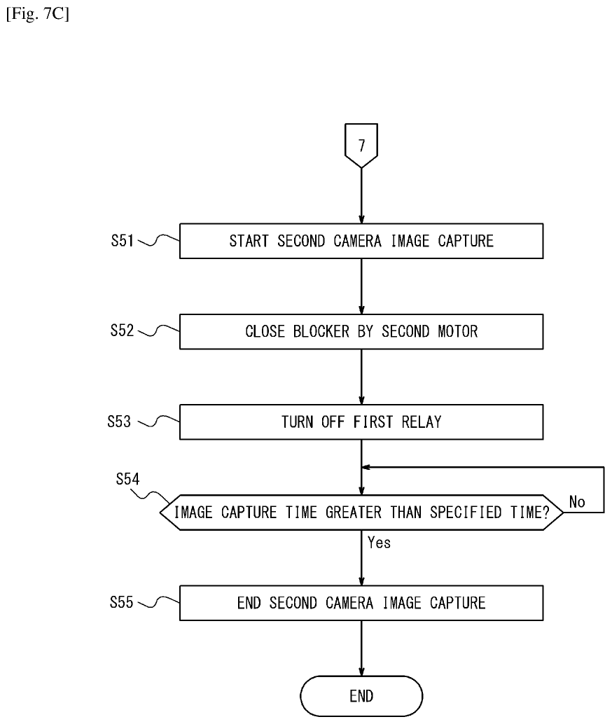

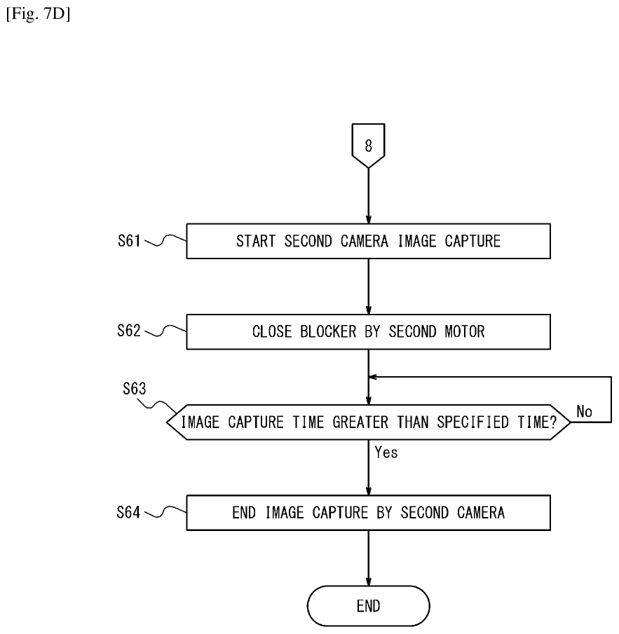

The measurement apparatus 1 may execute the example procedures illustrated in the flowcharts of FIG. 7A, FIG. 7B, FIG. 7C, and FIG. 7D to control the measurement apparatus 1 by the second control line L2 illustrated in FIG. 4.

The second controller 30b starts state monitoring regarding the measurement apparatus 1 (step S31 in FIG. 7A). The second controller 30b determines whether the normal power supply is on (step S32). When the normal power supply is on (step S32: Yes), the second controller 30b proceeds to step S41 in FIG. 7B. When the normal power supply is not on (step S32: No), that is, when the normal power supply is off, the second controller 30b turns on the second relay 41b of the second control line L2 (step S33).

The second controller 30b starts image capture of the defined area by the second camera 70b (step S34). The second controller 30b closes the blocker 10 using the second motor 42b (step S35).

The second controller 30b determines whether the image capture time by the second camera 70b is longer than the specified time (step S36). When the image capture time is not longer than the specified time (step S36: No), that is, when the image capture time is the specified time or less, the second controller 30b repeats the determination procedure of step S36 without ending the image capture by the second camera 70b, until the image capture time is longer than the specified time. When the image capture time is longer than the specified time (step S36: Yes), the second controller 30b ends the image capture by the second camera 70b (step S37). After execution of the procedure in step S37, the second controller 30b ends execution of the procedures of the flowchart of FIG. 7A.

Upon determining that the normal power supply is on in step S32 of FIG. 7A, the second controller 30b determines whether the measurement apparatus 1 is set to the maintenance mode (step S41 of FIG. 7B). When the measurement apparatus 1 is not set to maintenance mode (step S41: No), that is, when the measurement apparatus 1 is set to the operation mode, the second controller 30b determines whether intrusion into the virtual fence 2 has been detected by the detectors 60 (step S42). Upon detecting intrusion into the virtual fence 2 by the detectors 60 (step S42: Yes), the second controller 30b proceeds to step S61 in FIG. 7D.

When the measurement apparatus 1 is set to the maintenance mode (step S41: Yes) or no intrusion into the virtual fence 2 is detected by the detectors 60 (step S42: No), the second controller 30b determines whether the second detection information from the second sensor 20b is normal (Step S43). When the second detection information is not normal (step S43: No), the second controller 30b proceeds to step S61 in FIG. 7D.

When the second detection information is normal (step S43: Yes), the second controller 30b determines whether the second radiation dose obtained as a measurement from the second dosimeter 50b is less than the second threshold dose value (step S44). When the second radiation dose is not less than the second threshold dose value (step S44: No), that is, when the second radiation dose is the second threshold dose value or greater, the second controller 30b proceeds to step S61 in FIG. 7D.

When the second radiation dose is less than the second threshold dose value (step S44: Yes), the second controller 30b determines whether normal conditions have been met (step S45). When normal conditions have not been met (step S45: No), the second controller 30b proceeds to step S51 in FIG. 7C.

When normal conditions have been met (step S45: Yes), the second controller 30b executes opening or closing control of the blocker 10 using the second motor 42b of the second driver 40b (step S46). Specifically, the second controller 30b outputs a control signal to the second relay 41b to open the blocker 10 when measurement is to be performed by the measurement apparatus 1 and to close the blocker 10 when measurement is not to be performed by the measurement apparatus 1.

The second controller 30b determines that normal conditions have not been met when, for example, the first controller 30a fails and any control information, including the second control information, is not received from the first controller 30a. The second controller 30b determines that normal conditions have not been met upon receiving the first control information from the first controller 30a that is different from the second control information. The second control information includes control information to close the blocker 10 using the second motor 42b due to an abnormality in the second detection information from the second sensor 20b.

After controlling the opening or closing of the blocker 10 according to the procedure in step S46, the second controller 30b ends the state monitoring regarding the measurement apparatus 1 (step S47). The second controller 30b then returns to step S31 in FIG. 7A and repeats processing.

Upon determining that normal conditions have not been met in step S45 of FIG. 7B (step S45: No), the second controller 30b starts image capture of the defined area by the second camera 70b (step S51 in FIG. 7C). The second controller 30b closes the blocker 10 using the second motor 42b (step S52). The second controller 30b turns off the first relay 41a (step S53).

The second controller 30b determines whether the image capture time by the second camera 70b is longer than the specified time (step S54). When the image capture time is not longer than the specified time (step S54: No), that is, when the image capture time is the specified time or less, the second controller 30b repeats the determination procedure of step S54 without ending the image capture by the second camera 70b, until the image capture time is longer than the specified time. When the image capture time is longer than the specified time (step S54: Yes), the second controller 30b ends the image capture by the second camera 70b (step S55). After execution of the procedure in step S55, the second controller 30b ends execution of the procedures of the flowchart of FIG. 7C.

Upon determining that intrusion has been detected by the detectors 60 in step S42 of FIG. 7B, or determining that the second detection information is abnormal in step S43 of FIG. 7B, or determining that the second radiation dose is the second threshold dose in step S44 of FIG. 7B, the second controller 30b starts image capture of the defined area by the camera 70b (step S61 in FIG. 7D). The second controller 30b closes the blocker 10 using the second motor 42b (step S62).

The second controller 30b determines whether the image capture time by the second camera 70b is longer than the specified time (step S63). When the image capture time is not longer than the specified time (step S63: No), that is, when the image capture time is the specified time or less, the second controller 30b repeats the determination procedure of step S63 without ending the image capture by the second camera 70b, until the image capture time is longer than the specified time. When the image capture time is longer than the specified time (step S63: Yes), the second controller 30b ends the image capture by the second camera 70b (step S64). After execution of the procedure in step S64, the second controller 30b ends execution of the procedures of the flowchart of FIG. 7D. The second controller 30b does not turn off the first relay 41a in the flowchart of FIG. 7D, unlike the flowchart of FIG. 7C.

The measurement apparatus 1 executes normal opening or closing control of the blocker 10 only when both the first controller 30a and the second controller 30b determine that normal conditions have been met. At this time, of the processing of step S8 in FIG. 6B by the first controller 30a and the processing of step S46 in FIG. 7B by the second controller 30b, the measurement apparatus 1 executes only one that has earlier been determined to have met normal conditions. In other words, the measurement apparatus 1 ultimately executes normal opening or closing control of the blocker 10 based on only one of the first driver 40a or the second driver 40b.

On the other hand, the measurement apparatus 1 closes the blocker 10 by either the first drive 40a or the second drive 40b for all cases except when both the first controller 30a and the second controller 30b determine that normal conditions have been met. In other words, the measurement apparatus 1 executes the normal opening or closing control of the blocker 10 only when both the first controller 30a and the second controller 30b determine that doing so is safe, and closes the blocker 10 in all other cases so that the measurement apparatus 1 provides a safety function against radiation.

As described above, the measurement apparatus 1 is able to close the blocker 10 when intrusion into the defined area is detected by the detectors 60. The detectors 60 form the virtual fence 2 around the defined area that includes the radiation source of the measurement apparatus 1, thereby limiting the exposure of a human, animal, or the like that intrudes into the area around the radiation source.

When the detectors 60 operate as light-shielding sensors, the time between the detectors 60 detecting an intruder and outputting the detection result to the first controller 30a or the second controller 30b is short. The short time to output the detection result allows the measurement apparatus 1 to promptly close the blocker 10 in the event of intrusion into the defined area. In a case of taking longer to close the blocker 10 after an intruder intrudes into the defined area, the likelihood of the intruder being exposed to radiation increases. By promptly closing the blocker 10, the exposure of a human, animal, or the like that has intruded is suppressed.

The measurement apparatus 1 is able to image capture the defined area using the first camera 70a or the second camera 70b when the detectors 60 detect an intruder. By image capturing the defined area, the measurement apparatus 1 is able to monitor the movement of an intruder and ascertain an abnormal state of the measurement apparatus 1.

According to the embodiment described above, the measurement apparatus 1 may be configured to include only the first control line L1 without the second control line L2. Conversely, the measurement apparatus 1 may be configured to include only the second control line L2 without the first control line L1. By including only one of the first control line L1 or the second control line L2, the measurement apparatus 1 is able to promptly close the blocker 10 when a human, animal or the like intrudes into the virtual fence 2. The first controller 30a or the second controller 30b may also be referred to simply as a controller. The first camera 70a or the second camera 70b may also be referred to simply as a camera.

### Other Embodiments

The following describes example configurations of the measurement apparatus 1 according to other embodiments.

### <Other Examples of Detector 60>

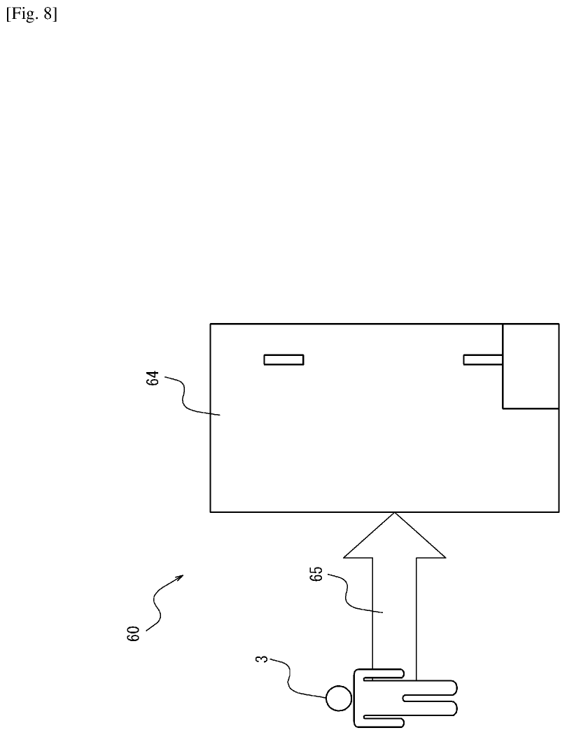

As illustrated in FIG. 8, the detector 60 may include a light receiver 64 that detects emitted light 65, such as far infrared radiation, emitted from the detection target 3. In such a case, the detector 60 may be configured as a far-infrared sensor or infrared sensor, or a far-infrared camera or infrared camera. The number of components required is reduced by the detector 60 not including the light emitter 61, and only including the light receiver 64. Further, the light receiver 64 may be installed on a ceiling, pillar, or the like. In other words, flexibility in the arrangement of the detectors 60 increases.

### <Example of Arrangement of Detectors 60>

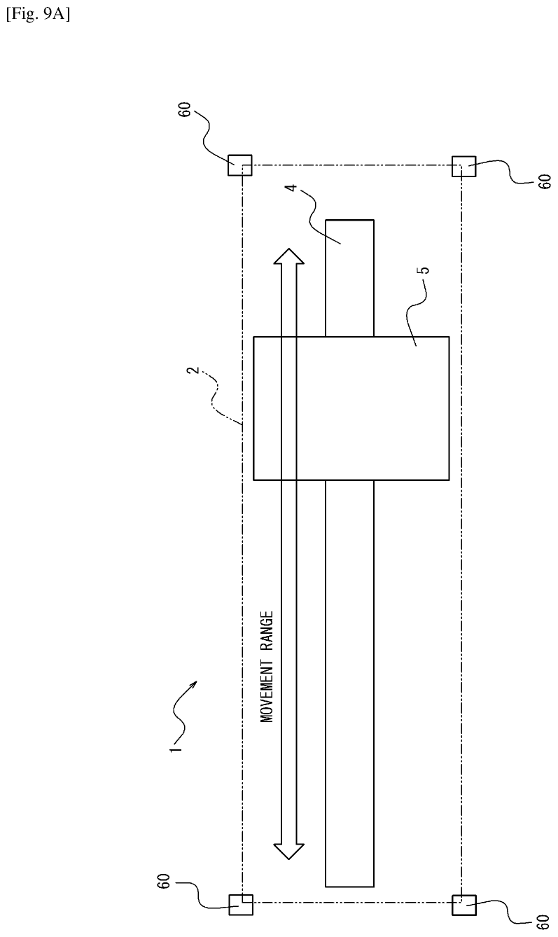

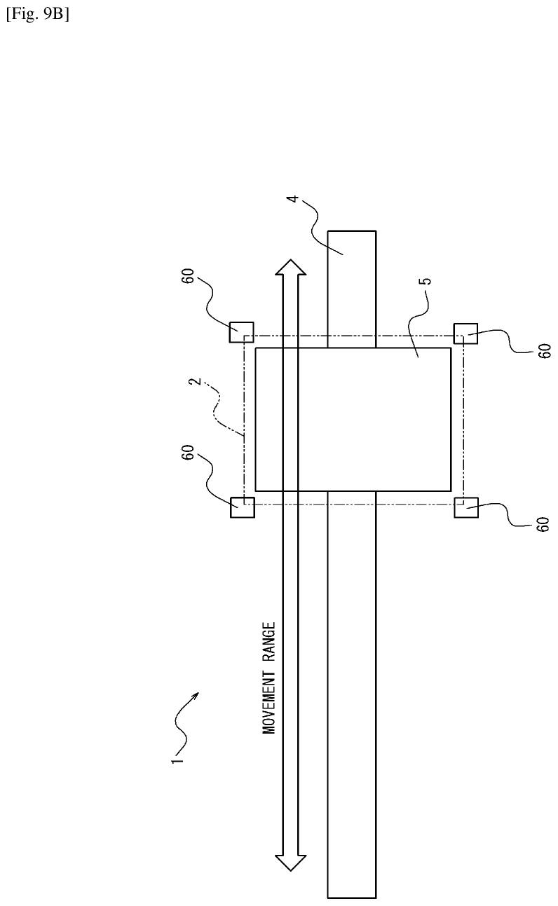

The measurement apparatus 1 may include a measurement head 5 including a radiation source and a head driver 4 configured to move the measurement head 5, as illustrated in FIG. 9A and FIG. 9B. The measurement apparatus 1 may include the detectors 60 arranged so that the entirety of the head driver 4, including the range of movement of the measurement head 5, forms the virtual fence 2 as the defined area, as illustrated in FIG. 9A.

The measurement apparatus 1 may include the detectors 60 arranged so that the virtual fence 2 is formed with only the measurement head 5 as the defined area, as illustrated in FIG. 9B. In other words, the detectors 60 may be arranged so that the defined area moves with the movement of the measuring head 5 that includes the radiation source.

When the detectors 60 are arranged so that the virtual fence as the defined area is formed only around the measuring head 5, the number of the detectors 60 may be reduced. Further, the distance between the light emitter 61 and the light receiver 62 of each of the detectors 60 may be shortened. As a result, the cost of the detectors 60 may be reduced.

When the detectors 60 are arranged so that the virtual fence 2 is formed with only the measuring head 5 as the defined area, the area where workers are prohibited from entering is smaller. In other words, the area that may be entered by workers is larger. As a result, space occupied by the measurement apparatus 1 is reduced. Further, worker movement is facilitated.

### <Control of the Blocker 10 Based on Memory Usage of Camera>

According to the embodiment described above, the measurement apparatus 1 uses the first camera 70a or the second camera 70b to image capture the defined area when the detectors 60 detect the detection target 3, when the normal power supply is lost, and when an abnormality occurs in the system. The measurement apparatus 1 may routinely image capture the defined area using the first camera 70a or the second camera 70b to monitor the state of safety controls in the defined area, regardless of the result of detection of an intruder by the detectors 60, the presence of normal power supply, and the system state.

The measurement apparatus 1 may further include a main processor such as a central processing unit (CPU). The main processor may be configured to remotely notify of abnormal information detected by image capture of the defined area via connection to a network such as the Internet or an intranet via a host system. Further, the measurement apparatus 1 may be configured to be controlled remotely. For example, when remotely notifying of abnormal information, the measurement apparatus 1 may start or end recording by the first camera 70a or the second camera 70b, execute video distribution, or the like, under control from the notification destination.

When the measurement apparatus 1 includes a main processor, the first controller 30a and the second controller 30b may write safety control information of the measurement apparatus 1, including recorded data captured by the first camera 70a or the second camera 70b, in a memory shared with the main processor. The first controller 30a or the second controller 30b may receive instructions from the main processor by periodically reading data from a designated area of memory shared with the main processor.

The main processor may periodically read the safety control information of the measurement apparatus 1, including the recorded data stored in the memory shared with the first controller 30a or the second controller 30b. Further, the main processor may send instructions to the first controller 30a or the second controller 30b by writing data to a designated area of shared memory. Further, the main processor may execute communications such as the Internet Protocol (IP) or fieldbus communications with the host system.

The host system may execute communications such as the IP or fieldbus communications with the main processor. The host system may also execute communications, such as the IP or fieldbus communications, with external devices that connect remotely.

In a case where the first camera 70a or the second camera 70b becomes unable to image capture, a safety issue may arise. For example, in a case where an abnormality occurs in the measurement apparatus 1 while the first camera 70a or the second camera 70b is unable to image capture, the opening and closing of the blocker 10 might not be properly controlled. Specifically, the memory usage of the first camera 70a or the second camera 70b may approach an upper limit, which may prevent the first camera 70a or the second camera 70b from image capture. The measurement apparatus 1 may control the blocker 10 based on the memory usage of the first camera 70a or the second camera 70b. By causing the blocker 10 to block when the memory usage of a camera is at a usage threshold or greater, a radiation leakage situation in which the blocker 10 fails to close while the camera is unable to image capture the defined area may be prevented.

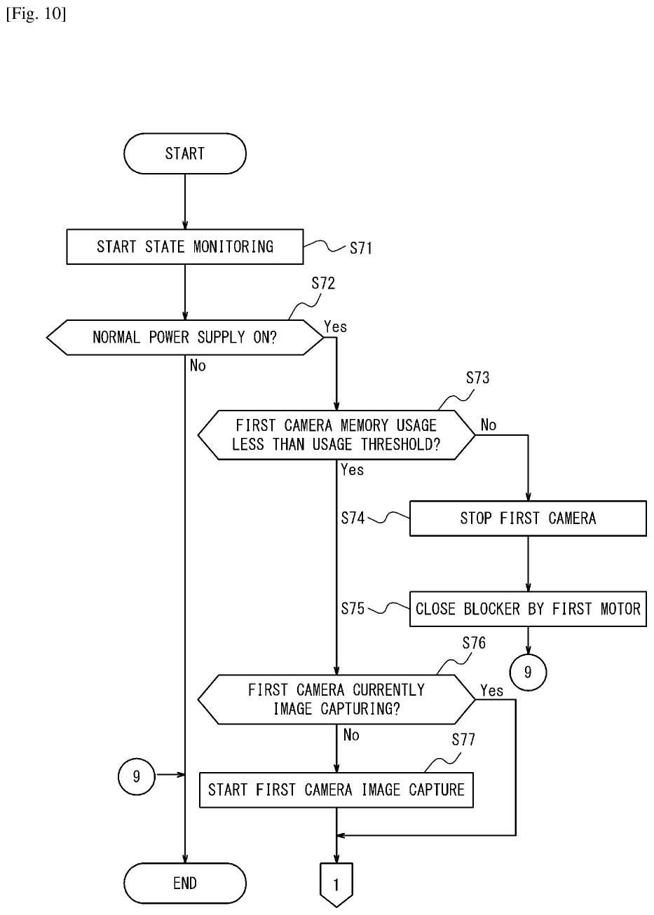

The measurement apparatus 1 may execute the example procedures of the flowchart of FIG. 10 to control the measurement apparatus 1 by the first control line L1 illustrated in FIG. 4.

The first controller 30a starts state monitoring regarding the measurement apparatus 1 (step S71). The first controller 30a determines whether the normal power supply is on (step S72). When the normal power supply is not on (step S72: No), that is, when the normal power supply is off, the first controller 30a ends execution of the procedures of the flowchart of FIG. 10.

When the normal power supply is on (step S72: Yes), the first controller 30a determines whether the memory usage of the first camera 70a is less than the usage threshold (step S73).

When the memory usage of the first camera 70a is not less than the usage threshold (step S73: No), that is, when the memory usage of the first camera 70a is at the usage threshold or greater, the first controller 30a stops image capture by the first camera 70a (step S74). The first controller 30a closes the blocker 10 using the first motor 42a (step S75). After execution of the procedure in step S75, the first controller 30a ends execution of the procedures of the flowchart of FIG. 10.

When the memory usage of the first camera 70a is less than the usage threshold (step S73: Yes), the first controller 30a determines whether the first camera 70a is image capturing the defined area (step S76). When not currently image capturing the defined area by the first camera 70a, the first controller 30a starts image capture of the defined area by the first camera 70a (step S77). Upon determining in the procedure of step S76 that the first camera 70a is image capturing the defined area (step S76: Yes) or after starting image capture of the defined area by the first camera 70a in the procedure of step S77, the first controller 30a proceeds to the procedure of step S3 in FIG. 6B to execute control of opening or closing the blocker 10.

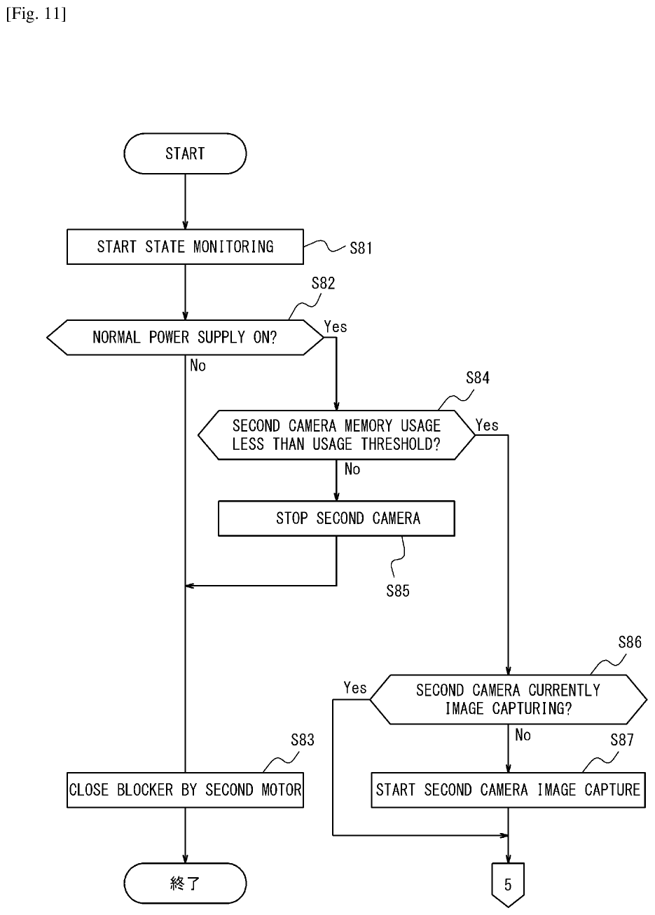

The measurement apparatus 1 may execute the example procedures of the flowchart of FIG. 11 to control the measurement apparatus 1 by the second control line L2 illustrated in FIG. 4.

The second controller 30b starts state monitoring regarding the measurement apparatus 1 (step S81). The second controller 30b determines whether the normal power supply is on (step S82). When the normal power supply is not on (step S82: No), that is, when the normal power supply is off, the second controller 30b closes the blocker 10 using the second motor 42b (step S83) After execution of the procedure in step S83, the second controller 30b ends execution of the procedures of the flowchart of FIG. 11.

When the normal power supply is on (step S82: Yes), the second controller 30b determines whether the memory usage of the second camera 70b is less than the usage threshold (step S84).

When the memory usage of the second camera 70b is not less than the usage threshold (step S84: No), that is, when the memory usage of the second camera 70b is at the usage threshold or greater, the second controller 30b stops image capture by the second camera 70b (step S85). After execution of the procedure of step S85, the second controller 30b proceeds to step S83, closes the blocker 10 using the second motor 42b, and ends execution of the procedures of the flowchart of FIG. 11.

When the memory usage of the second camera 70b is less than the usage threshold (step S84: Yes), the second controller 30b determines whether the second camera 70b is image capturing the defined area (step S86). When not currently image capturing the defined area by the second camera 70b, the second controller 30b starts image capturing the defined area by the second camera 70b (step S87). Upon determining in the procedure of step S86 that the second camera 70b is image capturing the defined area (step S86: Yes) or after starting image capture of the defined area by the second camera 70b in the procedure of step S87, the second controller 30b proceeds to the procedure of step S41 in FIG. 7B to execute control of opening or closing the blocker 10.

As described above, the measurement apparatus 1 is able to routinely monitor the state of the measurement apparatus 1 by using the first camera 70a or the second camera 70b to routinely image capture the defined area. Further, the measurement apparatus 1 is able to communicate with an external device using the main processor and host system to remotely notify the remote device of the state of the measurement apparatus 1 and to receive instructions remotely and securely from the external device.

Although the present disclosure has been described based on the drawings and examples, it should be noted that a person skilled in the art may make variations and modifications based on the present disclosure. Therefore, it should be noted that such variations and modifications are included within the scope of the present disclosure.

For example, functions and the like included in each configuration, step, and the like may be rearranged, and multiple configurations, steps, and the like may be combined into one or divided, as long as no logical inconsistency results.

For example, the present disclosure may be realized as a program describing the processing content to realize each function of the measurement apparatus 1 described above, or as a non-transitory computer-readable medium on which the program is stored. The scope of the present disclosure should be understood to include these examples.

For example, the arrangement and number of each of the above components are not limited to those illustrated in the above description and drawings. The arrangement and number of each component may be configured arbitrarily, as long as the function thereof is achievable.

### REFERENCE SIGNS LIST

1 measurement apparatus
2 virtual fence
3 detection target
4 head driver
5 measurement head
10 blocker
20a first sensor
20b second sensor
30a first controller
30b second controller
40a first driver
40b second driver
41a first relay
41b second relay
42a first motor
42b second motor
50a first dosimeter
50b second dosimeter
60, 60a-60d detector
61, 61a-61d light emitter
62, 62a-62d light receiver
63 detection light
64 light receiver
65 emitted light
70a first camera
70b second camera
L1 first control line
L2 second control line

1. A measurement apparatus for measuring thickness of an object to be measured using radiation, comprising:
a blocker able to block the radiation emitted by a radiation source;
a controller configured to control unblocking and blocking of the radiation by opening and closing the blocker; and
a detector configured to detect an intruder at a boundary of a defined area that includes the radiation source, wherein
the controller closes the blocker to block the radiation when the detector detects an intruder at the boundary of the defined area.

2. The measurement apparatus according to claim 1, further comprising a camera able to image capture the defined area, wherein
the controller starts the image capture of the defined area by the camera when the detector detects an intruder at the boundary of the defined area.

3. The measurement apparatus according to claim 1, further comprising a camera able to image capture the defined area, wherein
the controller causes the blocker to block when memory usage of the camera is at a usage threshold or greater.

4. The measurement apparatus according to claim 1, further comprising a head driver configured to move the radiation source, wherein
the detector is disposed so that the defined area moves along with movement of the radiation source.

5. A control method for a measurement apparatus that comprises a radiation source and a blocker able to block radiation, the measurement apparatus configured to measure thickness of an object to be measured using the radiation, the control method comprising:
detecting an intruder at a boundary of a defined area that includes the radiation source; and
closing the blocker to block the radiation when an intruder is detected at the boundary of the defined area.

6. The measurement apparatus according to claim 2, further comprising a head driver configured to move the radiation source, wherein
the detector is disposed so that the defined area moves along with movement of the radiation source.

7. The measurement apparatus according to claim 3, further comprising a head driver configured to move the radiation source, wherein
the detector is disposed so that the defined area moves along with movement of the radiation source.
